(19) United States
(12) Patent Application Publication
(10) Pub. No.: US 2024/0281196 A1
(43) Pub. Date: Aug. 22, 2024

(54) CONTROL AND MEMORY ACCESSES USING STREAMING AUDIO

(71) Applicant: Intel Corporation, Santa Clara, CA (US)

(72) Inventors: Satheesh CHELLAPPAN, Folsom, CA (US); Tomasz PIELASZKIEWICZ, Gdansk (PL)

(73) Assignee: Intel Corporation, Santa Clara, CA (US)

(21) Appl. No.: 18/571,586

(22) PCT Filed: Dec. 23, 2021
(86) PCT No.: PCT/PL2021/050092

§ 371 Date: Dec. 18, 2023

(51) Int. Cl. G06F 3/16

(52) U.S. Cl. CPC G06F 3/162

(57) ABSTRACT

A device system-on-a-chip (SoC) includes a streaming audio interface, a local memory, and a device controller coupled to the memory. The device controller is to decode an audio frame to generate a decoded audio frame. The audio frame is received via the streaming audio interface. The decoded audio frame is processed according to a streaming audio protocol to obtain corresponding control data and periodic streaming audio data. The control data is parsed to obtain a memory address pointer. Memory access to the local memory is performed based on the memory address pointer.

### TECHNICAL FIELD

Embodiments pertain to improvements in computer architectures, including improvements in power supply and power usage, including techniques for low power hardware autonomous control and memory accesses over a streaming audio interface.

### BACKGROUND

Some traditional audio interfaces (e.g., Inter-IC Sound (I2S) interfaces) are dedicated isochronous streaming interfaces and do not provide control or command transport. Other audio interfaces (e.g., High Definition Audio (HD-A)) provide an agent-level command for interface functionality, but rely on software involvement for all audio device class command or memory operations (e.g., polling the audio node registers or configuring the speakers or microphones). However, continuously involving software or embedded digital signal processing (DSP) firmware is power-intensive functionality that decreases the device's power efficiency.

### BRIEF DESCRIPTION OF THE DRAWINGS

In the drawings, like numerals may describe the same or similar components or features in different views. Like numerals having different letter suffixes may represent different instances of similar components. Some embodiments are illustrated by way of example, and not limitation, in the figures of the accompanying drawings in which:

FIG. 1 is a block diagram of a radio architecture including an interface card with a device system-on-a-chip (SoC) configured to perform autonomous control and memory accesses over a streaming audio interface, in accordance with some embodiments;

FIG. 2 illustrates a front-end module circuitry for use in the radio architecture of FIG. 1, in accordance with some embodiments;

FIG. 3 illustrates a radio IC circuitry for use in the radio architecture of FIG. 1, in accordance with some embodiments;

FIG. 4 illustrates a baseband processing circuitry for use in the radio architecture of FIG. 1, in accordance with some embodiments;

FIG. 5 illustrates SoundWire (SNDW) frame structure which can be used in accordance with some embodiments;

FIG. 6 illustrates a high-level diagram of a network topology for performing control and memory accesses over a streaming audio interface, in accordance with some embodiments;

FIG. 7 illustrates a diagram of a device SoC with a device controller configured to perform control and memory accesses over a streaming audio interface, in accordance with some embodiments;

FIG. 8 illustrates a flow diagram of a method for performing control and memory accesses over a streaming audio interface, in accordance with some embodiments; and

FIG. 9 illustrates a block diagram of an example machine upon which any one or more of the operations/techniques (e.g., methodologies) discussed herein may perform.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc., to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

The disclosed techniques include a hardware (HW) autonomous method for device class command and memory access with limited software involvement. More specifically, disclosed techniques can be used to extend the in-band control access of the audio interface, to device class control and memory access on the device controller side. The remote host controller can accept processing where the control and memory access are handled by HW, firmware (FW), or software (SW). The disclosed techniques include an HW autonomous target agent (e.g., a SoundWire (SNDW) device controller) that can be configured to handle all device class accesses mapped directly to a local static random-access memory (SRAM) (e.g., a level 2 embedded system memory).

Some efficiencies associated with the disclosed techniques include low-power, low-memory, and low-cost processing of control and memory accesses, and eliminating the need for a dedicated interface for device class accesses. An additional benefit of using a streaming audio interface is the reduction of interface wiring in device hinges (e.g., monitor hinges). The disclosed techniques can be used for building an HW autonomous architecture compatible with a remote SNDW host controller, which eliminates the cost of software engineering development and the use of software vendors' inbox driver support. In this regard, runtime device class configuration and support of premium audio features can be achieved while maintaining low-power implementation (e.g., during playback with auto echo cancellation (AEC) configurations).

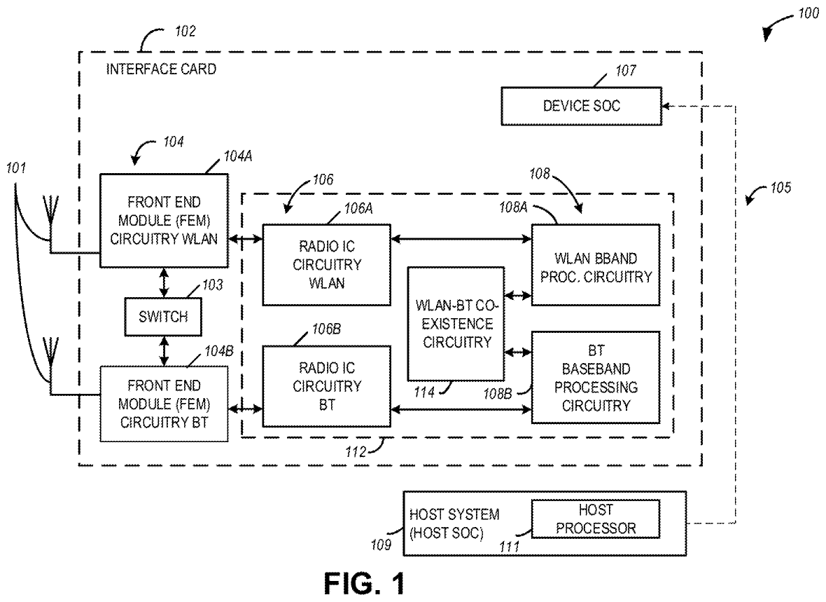

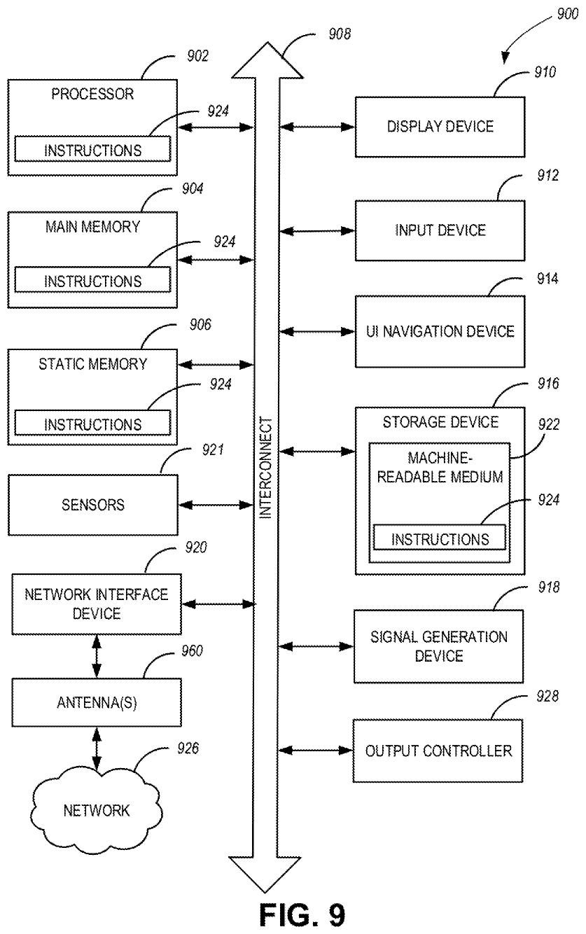

FIG. 1 is a block diagram of a radio architecture 100 including an interface card 102 with a device SoC 107 configured to perform autonomous control and memory accesses over a streaming audio interface, in accordance with some embodiments. The radio architecture 100 may be implemented in a computing device (e.g., device 900 in FIG. 9) including user equipment (UE), a base station (e.g., a next generation Node-B (gNB), enhanced Node-B (eNB)), a smartphone, a personal computer (PC), a laptop, a tablet, or another type of wired or wireless device. The radio architecture 100 may include radio front-end module (FEM) circuitry 104, radio integrated circuit (IC) circuitry 106, and baseband processing circuitry 108 configured as part of the interface card 102. In this regard, radio architecture 100 (as shown in FIG. 1) includes an interface card 102 configured to perform both Wireless Local Area Network (WLAN) functionalities and Bluetooth (BT) functionalities (e.g., as WLAN/BT interface or modem card), although embodiments are not so limited and the disclosed techniques apply to other types of radio architectures with different types of interface cards as well. In this disclosure, “WLAN” and “Wi-Fi” are used interchangeably. Other example types of interface cards which can be used in connection with the disclosed techniques include graphics cards, network cards, SSD cards (such as M.2-based cards), CEM-based cards, etc.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals, and to provide the amplified versions of the received signals to the WLAN radio IC circuitry 106A for further processing. The BT FEM circuitry 104B may include a receive signal path which may include circuitry configured to operate on BT RF signals received from the one or more antennas 101, to amplify the received signals and to provide the amplified versions of the received signals to the BT radio IC circuitry 106B for further processing. The FEM circuitry 104A may also include a transmit signal path which may include circuitry configured to amplify WLAN signals provided by the radio IC circuitry 106A for wireless transmission by the one or more antennas 101. Besides, the FEM circuitry 104B may also include a transmit signal path which may include circuitry configured to amplify BT signals provided by the radio IC circuitry 106B for wireless transmission by the one or more antennas. In the embodiment of FIG. 1, although FEM 104A and FEM 104B are shown as being distinct from one another, embodiments are not so limited and include within their scope the use of a FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. The BT radio IC circuitry 106B may, in turn, include a receive signal path which may include circuitry to down-convert BT RF signals received from the FEM circuitry 104B and provide baseband signals to BT baseband processing circuitry 108B. The WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. The BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform (FFT) or Inverse Fast Fourier Transform (IFFT) block (not shown) of the WLAN baseband processing circuitry 108A. Each of the WLAN baseband processing circuitry 108A and the BT baseband processing circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include a physical layer (PHY) and medium access control layer (MAC) circuitry and may further interface with the host processor 111 in the host system (e.g., host SoC) 109 for generation and processing of the baseband signals and for controlling operations of the radio IC circuitry 106.

Referring still to FIG. 1, according to the shown embodiment, WLAN-BT coexistence circuitry 114 may include logic providing an interface between the WLAN baseband processing circuitry 108A and the BT baseband processing circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the one or more antennas 101 are depicted as being respectively connected to the WLAN FEM circuitry 104A and the BT FEM circuitry 104B, embodiments include within their scope the sharing of the one or more antennas 101 as between the WLAN and BT FEMs, or the provision of more than one antenna connected to each of FEM 104A or 104B.

In some embodiments, the front-end module circuitry 104, the radio IC circuitry 106, and the baseband processing circuitry 108 may be provided on a single radio card, such as the interface card 102. In some other embodiments, the one or more antennas 101, the FEM circuitry 104, and the radio IC circuitry 106 may be provided on a single radio card. In some other embodiments, the radio IC circuitry 106 and the baseband processing circuitry 108 may be provided on a single chip or IC, such as IC 112.

In some embodiments, the interface card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

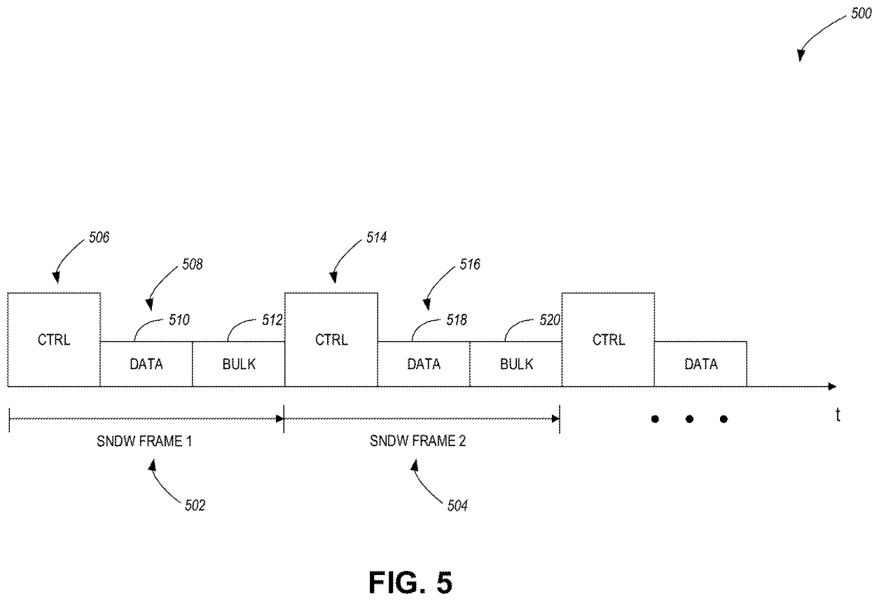

In some embodiments, the interface card 102 may include a device SoC 107 which can be in communication with a host SoC 109 (with a host processor 111) via a communication interface 105. In some aspects, such communication can be used in connection with autonomous control and memory accesses configured via the communication interface 105. In some embodiments, communication interface 105 can include a streaming audio interface such as an SNDW interface. A more detailed description of the host SoC 109 and the device SoC 107 as well as control and memory access related functionalities are provided in connection with, e.g., FIGS. 5-8.

In some of these multicarrier embodiments, radio architecture 100 may be part of a Wi-Fi communication station (STA) such as a wireless access point (AP), a base station, or a mobile device including a Wi-Fi enabled device. In some of these embodiments, radio architecture 100 may be configured to transmit and receive signals in accordance with specific communication standards and/or protocols, such as any of the Institute of Electrical and Electronics Engineers (IEEE) standards including, 802.11n-2009, IEEE 802.11-2012, 802.11n-2009, 802.11ac, IEEE 802.11-2016, and/or 802.11ax standards and/or proposed specifications for WLANs, although the scope of embodiments is not limited in this respect. Radio architecture 100 may also be suitable to transmit and/or receive communications in accordance with other techniques and standards, including a 3^{rd} Generation Partnership Project (3GPP) standard, including a communication standard used in connection with 5G or new radio (NR) communications.

In some embodiments, the radio architecture 100 may be configured for high-efficiency (HE) Wi-Fi communications in accordance with the IEEE 802.11ax standard or another standard associated with wireless communications. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband processing circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection-oriented (SCO) link and or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as the interface card 102, although embodiments are not so limited, and include within their scope discrete WLAN and BT radio cards

In some embodiments, the radio architecture 100 may include other radio cards, such as a cellular radio card configured for cellular (e.g., 3GPP such as LTE, LTE-Advanced, or 5G communications), which may be implemented together with (or as part of) the interface card 102.

In some IEEE 802.11 embodiments, the radio architecture 100 may be configured for communication over various channel bandwidths including bandwidths having center frequencies of about 900 MHZ, 2.4 GHZ, 5 GHZ, and bandwidths of about 1 MHZ, 2 MHZ, 2.5 MHZ, 4 MHZ, 5 MHz, 8 MHZ, 10 MHZ, 16 MHZ, 20 MHZ, 40 MHz, 80 MHZ (with contiguous bandwidths) or 80+80 MHZ (160 MHZ) (with non-contiguous bandwidths). In some embodiments, a 320 MHZ channel bandwidth may be used. The scope of the embodiments is not limited with respect to the above center frequencies, however.

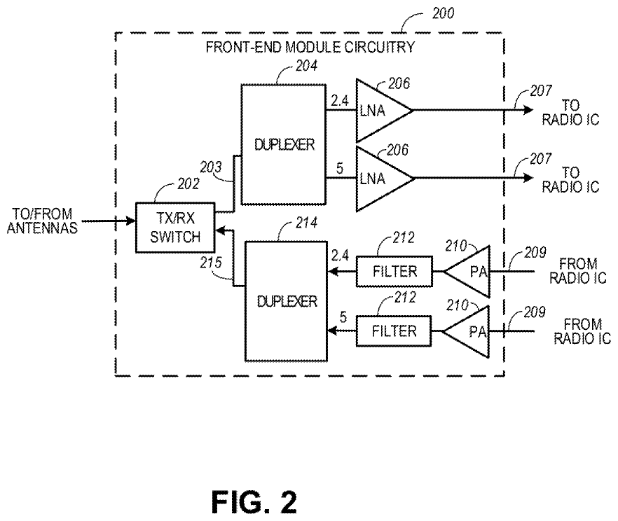

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit (TX) mode and receive (RX) mode operation. In some aspects, a diplexer may be used in place of a TX/RX switch. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the FEM circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by the one or more antennas 101 (FIG. 1)).

In some dual-mode embodiments for Wi-Fi communication, the FEM circuitry 200 may be configured to operate in, e.g., either the 2.4 GHz frequency spectrum or the 5 GHZ frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier (PA) 210 and one or more filters 212, such as a BPF, an LPF, or another type of filter for each frequency spectrum, and a transmit signal path duplexer 214 to provide the signals of one of the different spectrums onto a single transmit path for subsequent transmission by the one or more antennas 101 (FIG. 1). In some embodiments, BT communications may utilize the 2.4 GHz signal paths and may utilize the same FEM circuitry 200 as the one used for WLAN communications.

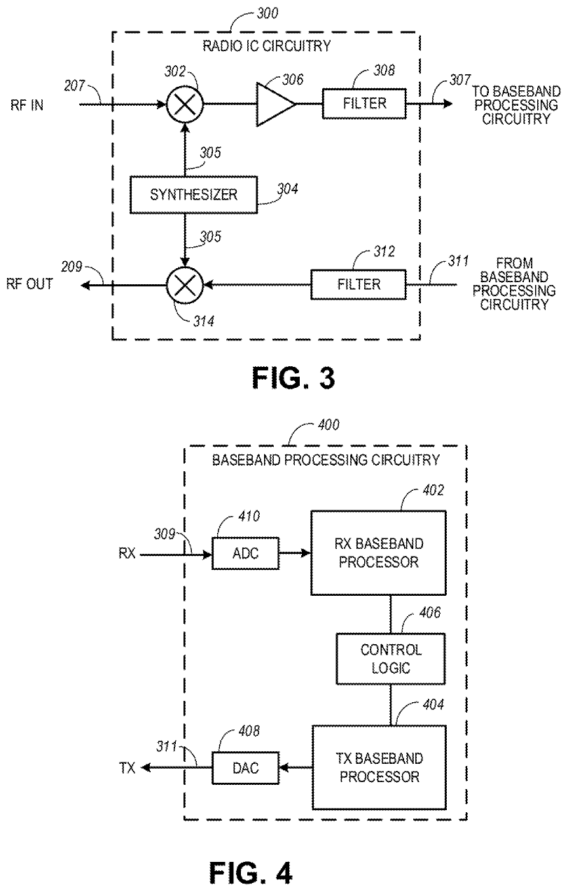

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include mixer circuitry 302, such as, for example, down-conversion mixer circuitry, amplifier circuitry 306, and filter circuitry 308. The transmit signal path of the radio IC circuitry 300 may include at least filter circuitry 312 and mixer circuitry 314, such as up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry and may include, although not shown, embodiments where each of the depicted circuitries may include more than one component. For instance, mixer circuitry 302 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by the synthesizer circuitry 304. The amplifier circuitry 306 may be configured to amplify the down-converted signals and the filter circuitry 308 may include an LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include an LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of the synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature-phase (Q) paths). In such an embodiment, RF input signal 207 from FIG. 2 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in the duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature-phase (Q) path) may operate at a 25% duty cycle, which may result in a significant reduction in power consumption.

The RF input signal 207 (FIG. 2) may comprise a balanced signal, although the scope of the embodiments is not limited in this respect. The I and Q baseband output signals may be provided to the low-noise amplifier, such as amplifier circuitry 306 (FIG. 3) or to filter circuitry 308 (FIG. 3).

In some embodiments, the output baseband signals 307 and the input baseband signals 311 may be analog, although the scope of the embodiments is not limited in this respect. In some alternate embodiments, the output baseband signals 307 and the input baseband signals 311 may be digital. In these alternate embodiments, the radio IC circuitry may include an analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. In some embodiments, the synthesizer circuitry 304 may be a delta-sigma synthesizer, a frequency multiplier, or a synthesizer comprising a phase-locked loop with a frequency divider. According to some embodiments, the synthesizer circuitry 304 may include a digital frequency synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage-controlled oscillator (VCO), although that is not a requirement. A divider control input may further be provided by either the baseband processing circuitry 108 (FIG. 1) or the host processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the host processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (fLO).

FIG. 4 illustrates a baseband processing circuitry 400 for use in the radio architecture of FIG. 1, in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include an analog-to-digital converter (ADC) 410 to convert analog baseband signals 309 received from the radio IC circuitry 106 to digital baseband signals for processing by the RX BBP 402. In these embodiments, the baseband processing circuitry 400 may also include a digital-to-analog converter (DAC) 408 to convert digital baseband signals from the TX BBP 404 to analog baseband signals 311.

In some embodiments that communicate OFDM signals or OFDMA signals, such as through the WLAN baseband processing circuitry 108A, the TX BBP 404 may be configured to generate OFDM or OFDMA signals as appropriate for transmission by performing an inverse fast Fourier transform (IFFT). The RX BBP 402 may be configured to process received OFDM signals or OFDMA signals by performing an FFT. In some embodiments, the RX BBP 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the one or more antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. The one or more antennas 101 may each include a set of phased-array antennas, although embodiments are not so limited.

Although the radio architecture 100 is illustrated as having several separate functional elements, one or more of the functional elements may be combined and may be implemented by combinations of software configured elements, such as processing elements including digital signal processors (DSPs), and/or other hardware elements. For example, some elements may comprise one or more microprocessors, DSPs, field-programmable gate arrays (FPGAs), application-specific integrated circuits (ASICs), radio-frequency integrated circuits (RFICs), and combinations of various hardware and logic circuitry for performing at least the functions described herein. In some embodiments, the functional elements may refer to one or more processes operating on one or more processing elements.

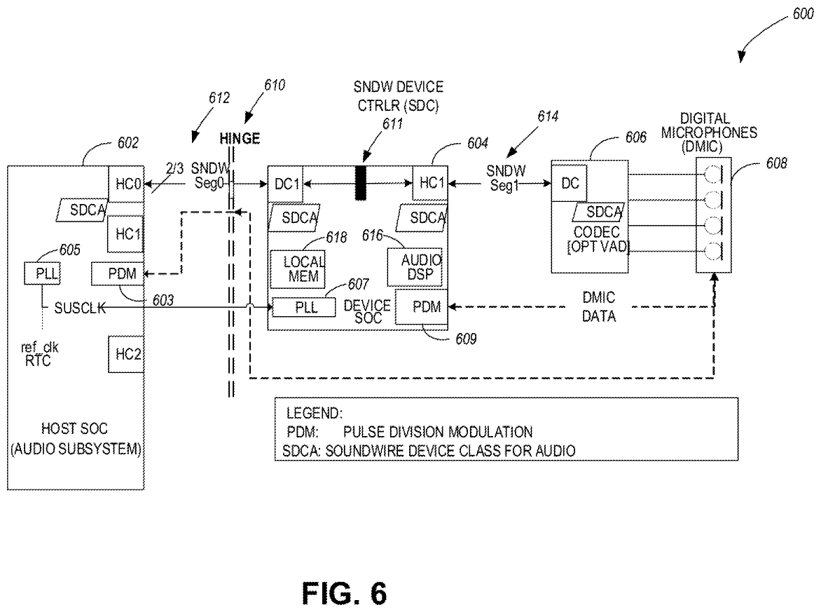

FIG. 5 illustrates diagram 500 of an SNDW frame structure which can be used in accordance with some embodiments. Referring to FIG. 5, diagram 500 illustrates example SNDW frames 502 and 504. Each SNDW frame can include control information followed by data such as periodic audio stream data. For example, SNDW frame 502 includes control information 506 and data 508. In some embodiments, data 508 can include periodic audio stream data (or audio data) 510 as well as additional data such as bulk data 512. Similarly, SNDW frame 502 includes control information 514 and data 516. Data 516 can include audio data 518 and bulk data 520. In some embodiments, bulk data can include asynchronous data such as historic data (e.g., history buffer data), additional control information such as one or more single-byte commands, or another type of data or control information. In some embodiments, control information and bulk data associated with an SNDW frame received via a streaming audio interface (e.g., an SNDW compliant interface) can be used for configuring autonomous control and memory accesses as discussed in connection with FIG. 6-FIG. 8.

FIG. 6 illustrates a high-level diagram of a network topology 600 for performing control and memory accesses over a streaming audio interface, in accordance with some embodiments. Referring to FIG. 6, the network topology 600 includes a host SoC 602 (which can be in an audio subsystem associated with a computing device), a device SoC 604, Codec 606, and digital microphones 608. The host SoC 602 can include a phase-locked loop (PLL) circuit 605, a pulse division modulation (PDM) circuit 603, and multiple host controllers (HCs) such as HC0-HC2. The PLL circuit 605 can be a source of a reference clock signal which can be supplied to the device SoC 604.

PDM circuit 603 can be used for communication and processing of audio data such as data received from the digital microphones 608 via the streaming audio interface 612.

The host SoC 602 can be connected to the device SoC 604 via a streaming audio interface 612 passing through hinge 610. The streaming audio interface 612 can be an SNDW interface (also referred to as SNDW segment 0).

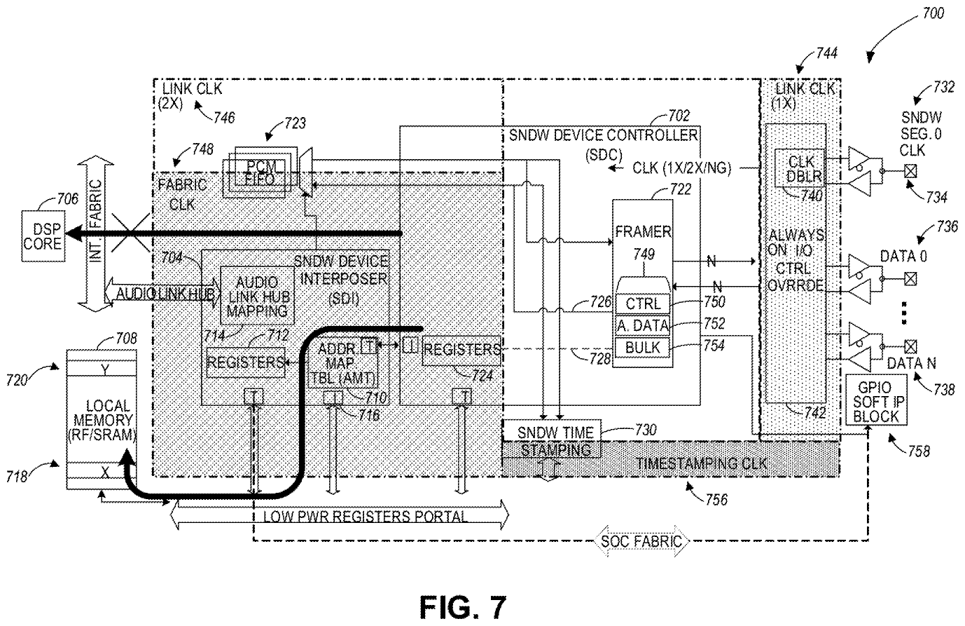

Device SoC 604 can comprise an audio DSP 616, local memory 618, a device controller 611 (also referred to as SNDW device controller or SDC), a PLL circuit 607, and a PDM circuit 609. The audio DSP 616 can be configured to perform audio data processing functions as well as management functions in connection with control and memory accesses associated with local memory 618. SDC 611 can be used as a device controller (e.g., DC1) coupled to the corresponding HC0 via the streaming audio interface 612. SDC 611 can also be used as a host controller (e.g., HC1) coupled to a corresponding device controller (e.g., DC) of Codec 606 via the streaming audio interface 614 (which can be referred to as SNDW segment 1). A more detailed description of the SDC 611 is provided in connection with FIG. 7.

The PLL circuit 607 can be PLL configured to supply one or more system clock signals received from PLL 605 of the host SoC 602. The PDM circuit 609 can be configured to process audio data such as data received from the digital microphones 608.

In some embodiments, one or more of the HCs in the host SoC 602, the device SoC 604, and the Codec 606 can be compliant with one or more audio-related protocols such as SoundWire Device Class for Audio (SDCA) protocol.

FIG. 7 illustrates a diagram of a device SoC 700 with a device controller (e.g., SDC 702) configured to perform control and memory accesses over a streaming audio interface, in accordance with some embodiments. Referring to FIG. 7, the device SoC 700 (which can be similar to device SoC 604) comprises a DSP core 706 (e.g., similar to DSP 616), local memory 708 (e.g., similar to local memory 618), SDC 702, SNDW device interposer (SDI) 704, I/O controller 742, buffer 723 (e.g., a pulse code modulation first-in-first-out (PCM FIFO) buffer), a time-stamping circuit 730, and a general-purpose I/O (GPIO) circuit 758.

The SDC 702 can include registers 724 and a framer circuit 722. The SDI 704 includes an audio link hub (ALH) mapping circuit 714, registers 712, and mapping table (AMT) 710.

Device SoC further includes streaming audio interface 732, such as SNDW interface (e.g., SNDW segment 0 of FIG. 6). In some aspects, the streaming audio interface 732 includes a clock signal line 734 and single or multiple data lines (e.g., 1 through 8 data lines) 736, . . . , 738.

During operation, device SoC 700 receives an audio frame 749 via the streaming audio interface 732. Audio frame 749 can be an SNDW frame (similar to the frames illustrated in FIG. 5) which can be decoded by the framer circuit 722 to obtain control data 750, periodic streaming audio data (also referred to as audio data) 752, and asynchronous (or bulk) data 754. The audio data 752 can be forwarded for subsequent processing to buffer 723 via communication link 726. Control data 750 and bulk data 754 can be forwarded and stored in registers 724 via communication link 728. Control data 750 and bulk data 754 can be communicated to SDI 704 for further processing in connection with autonomous control and memory access functionalities. In some embodiments, control data 750 and bulk data 754 can be converted to a bus compliant protocol such as Advanced High-performance Bus (AHB), Advanced extensible Interface (AXI) bus (or AXB), or another type of bus protocol, before communication to registers 724 or before communication to SDI 704.

SDI 704, which can also be referred to as SNDW device translation circuit, decodes (or parses) control data 750 to obtain a memory access command (e.g., a memory Read or Write command) as well as a memory address pointer. For example, the memory address pointer is obtained via the AMT 710. SDI 704 can perform a verification of the memory address pointer to verify whether the memory address pointer is valid or invalid. If the memory address pointer is invalid, SDI 704 can cause the DSP core 706 to transition from a low power state to a normal power state (e.g., using a validation request communicated via the initiator block 716) to perform a validation of local memory 708. After validation, an updated memory address pointer is obtained and the memory access command can be performed using the updated memory address pointer. If the memory address pointer is valid, SDI 704 can perform memory access to local memory 708 and perform the memory access command.

In an example embodiment, data (e.g., control data 750 and bulk data 754) can be forwarded to registers 724 via communication link 728, and then to SDI 704 for further processing. In some aspects, bulk data 754 can include additional memory access commands which can be mapped via the AMT 710 to a memory address pointer and then execute the memory access in connection with local memory 708.

In some embodiments, the memory access commands associated with commands communicated with control data 750 can be configured with memory address pointers for a memory region 718 of local memory 708, while memory access commands associated with bulk data 754 can be configured with memory address pointers for memory region 720 of local memory 708. In some aspects, memory regions 718 and 720 are nonoverlapping regions of local memory 708.

In some embodiments, DSP core 706 can be configured to remain in a low-power state while audio frame 749 is decoded and processed to obtain control data 750, audio data 752, and bulk data 754, as well as during control and memory accesses performed based on memory access commands communicated via the control data 750 or bulk data 754. DSP core 706 can transition from a low power state to a normal power state only when SDI 704 requests revalidation of local memory 708 based on unsuccessful verification of a memory address pointer.

In some embodiments, device SoC 700 can include different clock domains associated with different clock signals. For example, FIG. 7 illustrates for different domains of device SoC 700 associated with different shading in FIG. 7. For example, the initial processing of data received via the streaming audio interface 732 and data processed by the I/O controller 742 is associated with a first clock signal 744. A clock doubler circuit 740 can be used to generate a doubled clock signal 746 used as a link clock. A fabric clock signal 748 can be used by SDI 704 and registers 724 as well as locations associated with SDI 704. A timestamping clock 756 can be used by the time-stamping circuit 730, which is configured to perform time stamping of data communicated via communication links 726 and 728.

Even though SDI 704 is illustrated in FIG. 7 as a separate circuit, the disclosure is not limited in this regard and SDI 704 can be implemented as part of SDC 702.

In some aspects, SDC 702 can be part of a companion chip implemented on a lid side of a computing device such as a laptop. The disclosed functionalities can be used to enable control and direct memory access (DMA) without runtime involvement of DSP core 706, allowing control and memory accesses during low power operation of the DSP. These accesses can be Read or Write accesses based on a device class driver that is executing the platform audio application.

In some aspects, SDC 702 can reside in other device controller chips, a Codec chip, or other device components (e.g., interface card as illustrated in FIG. 1) and greatly reduce the overall system power for multiple Codecs in the platform.

In some embodiments, SDC 702 can be configured to tunnel the device class access through audio interface in-band, and not use a dedicated interface like I2C/I3C or SPI to route across the laptop hinge. In this case, a streaming audio interface (e.g., SNDW audio interface) can be used for detecting and decoding the device class range in the device controller and route the access to an interposer block (e.g., SDI 704) which further remaps to local memory in the range of few MB of SRAM (which hides the address space in system memory).

The following configurations may be used in connection with an HW implementation of the SDC 702 to achieve the disclosed low power functions:

(a) An in-box driver (e.g., a Microsoft driver) can be used on the remote host SoC (e.g., host SoC 602) and configure the platform during runtime. The dependency of a Smart-Codec BIOS is eliminated and LP runtime audio node configuration is enabled.

(b) The SoundWire PHY and link layers can be configured, and the platform topology configuration can be initialized for baseline electrical operation.

(c) The DSP core 706 FW on the SoundWire device (e.g., SDC 702) can be used to initialize the HW autonomous control and configuration registers and data structure in the interposer block (e.g., SDI 704).

(d) The DSP core 706 FW allocates and performs a setup of the local memory for audio node configurations. The remote host SoC can poll the runtime status from the hardware.

In some embodiments, after the above setup configurations, the device SoC 700 can enter a low power state, with the DSP core 706 in a power gated state (e.g., waiting for interrupt), with the streaming audio interface 732 active. The remote host SoC may enter a modern connected standby (MCS) state opportunistically.

In some embodiments, the following configurations can be used for the device SoC 700 in connection with supporting HW autonomous access using a streaming audio interface.

In some embodiments, an initial action of the remote host (e.g., host SoC 602) is to set up the audio interface (e.g., streaming audio interface 612 or 732) bandwidth to a maximum desired performance. This can be performed by setting up the bus clock frequency and the device PHY control registers to optimal skew, capacitance, and drive strength settings. In some aspects, the PHY programming can be performed by a set of control register Writes and Reads issued by the remote host and executed autonomously by HW (e.g., as described above in connection with FIG. 7), where the setting directly updates the controls in the PHY.

In some embodiments, during active streaming using the streaming audio interface, either a playback operation (e.g., streaming audio to headphone speakers during a voice call) and/or capture (e.g., recording microphone voice for a voice call), there could be runtime audio node configuration from the remote host in the form of a device class control access. These can be routed to the interposer block (e.g., SDI 704) via address decoding and handled by HW without the involvement of the DSP core 706. The Reads can be fully HW autonomously performed by mapping the registers to the local memory 708 (which can be SRAM). Writes can be moderated in a queue and handled by HW based on the severity of the register access. Optionally for Writes, an interrupt can be generated to the DSP core 706 when the HW is not configured to handle the commands autonomously.

In some embodiments, during runtime, there are audio functional data structures that include access by platform audio configuration from the remote host SoC. Such accesses can be handled by separate dedicated sideband interfaces, such as I2C/I3C or SPI. The disclosed techniques allow routing the DMA memory access through the in-band streaming audio interface, which are then handled autonomously by HW (e.g., as discussed in connection with FIG. 7). In some aspects, a separate memory region is allocated in the local memory 708 for such processing (e.g., memory regions 718 and 720). The reads and writes accesses can be autonomously handled by HW and writes have an option to generate interrupts on critical DMA access, e.g., updating shadow copy of profile data.

In some embodiments, similar to the DMA memory access, there could be other implementation-specific DMA access that is not part of the host SoC in-box drivers (e.g., these accesses could be firmware updates of the companion chip such as the device SoC 700). In some aspects, such accesses for firmware updates or other configuration functions can be performed via the streaming audio interface 732 or the GPIO circuit 758. The disclosed techniques allow for routing implementation-specific accesses through an in-band streaming audio interface, which can be handled autonomously by HW. An example for Write access could be downloading an FW image or machine learning (ML) models (e.g., with a size of approximately 2 MB) through Bulk Register Access (BRA), and interrupting DSP when the device is out of LP state, triggered by a wake on voice or policy settings. An example for Read access could be reading debug trace data via implementation-specific DMA reads. Traditionally, audio interfaces do not support FW download writes, or debug reads, and BRA access is handled by the DSP core in smaller chunks. The disclosed techniques include a method to accomplish implementation access via the HW autonomously.

In some embodiments, the disclosed techniques include autonomous methods allowing the interposer block (e.g., SDI 704) to save the context before entering ClockStop Mode 1 (where the contents are not preserved), and restoring the context after exiting this mode. In some aspects, the save-restore can be done in an AON-persistent local memory SRAM, which allows for further power saving of the overall platform.

The disclosed techniques can be associated with the following power-saving configurations and benefits:

(a) The disclosed techniques support active power-saving features including local dynamic clock gating (e.g., clock gating the unused modules mainly the HW autonomous modules), and enabling the retention power gating of the local SRAMs when not used.

(b) The DSP can be power-gated during HW autonomous operation and a small AON PM block powers up the DSP on wake interrupt.

(c) The device class accesses can include control Read, and sometimes control Writes, which gives maximum power saving from the disclosed techniques. The DMA accesses, either memory or implementation-specific, are not common and on-demand access based on policy from remote host SoC can be used.

(d) The platform key performance indicators (KPIs) for client SoC rely on effective power saving during wake-on-voice (WoV) processing. The WoV function connected to a digital microphone can achieve a power target of ˜1 mW power adder. Without the HW autonomous support, the power added would be doubled (+1 mW) because of the DSP process and subsystem power adder. The disclosed techniques eliminate the 2× power adder and allow for keeping the KPI target on par for a next generation SoC.

In some embodiments, a device SoC 700 includes a streaming audio interface 732, local memory 708, and device controller (e.g., SDC 702 which can also include SDI 704) coupled to the memory. SDC 702 is configured to decode an audio frame 749 which is received via the streaming audio interface 732. SDC 702 is further configured to process the decoded audio frame according to a streaming audio protocol (e.g., an SNDW protocol) to obtain corresponding control data 750 and periodic streaming audio data (e.g., audio data 752). SDC 702 is further configured to parse the control data 750 to obtain a memory address pointer and perform memory access to the local memory 708 based on the memory address pointer.

In some embodiments, the streaming audio interface is a SoundWire audio interface, and the audio frame 749 is a SoundWire audio frame. In some aspects, SDC 702 is configured to forward the periodic streaming audio data 752 of the SoundWire audio frame to a local buffer 723. The local buffer 723 can be separate from the local memory 708.

In some embodiments, the SDC 702 is further to process the control data 750 to obtain a memory access command. The SDC 702 is further to determine the memory address pointer based on an address mapping table and the memory access command.

In some aspects, the SDC 702 is further to perform a verification of the memory address pointer. The SDC 702 is further to perform the memory access command using the memory address pointer associated with the local memory, based on a result of the verification indicating that the memory address pointer is valid.

In some embodiments, the device SoC 700 further includes a DSP core 706. The SDC 702 is further to cause the DSP to perform a validation of the local memory 708, based on a result of the verification indicating that the memory address pointer is invalid.

In some embodiments, the SDC 702 is further to determine an updated memory address pointer subsequent to the validation, based on the address mapping table and the memory access command. The SDC 702 is further to perform the memory access command using the updated memory address pointer associated with the local memory.

In some embodiments, the SDC 702 is further to cause the DSP core 706 to transition from a low-power state to a normal power state before performing the validation of the local memory. In some embodiments, the SDC 702 is further to process the decoded audio frame according to the streaming audio protocol to further obtain bulk data.

In some aspects, the SDC 702 is further to process the bulk data to obtain a second memory access command and determine a second memory address pointer based on an address mapping table and the second memory access command. In some embodiments, the SDC 702 is further to perform the second memory access command using the second memory address pointer associated with the local memory. In some aspects, the second memory address pointer and the memory address pointer are associated with corresponding non-overlapping memory address spaces (e.g., memory address regions 718 and 720) of the local memory 708.

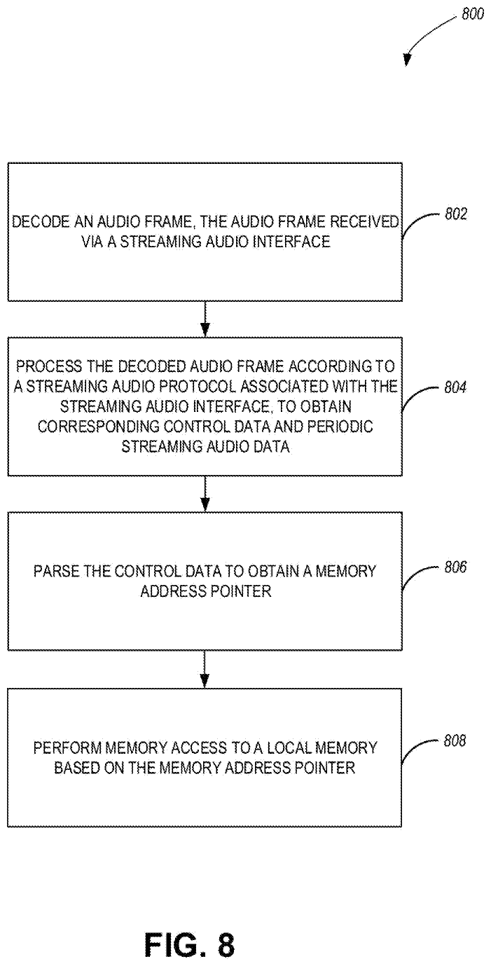

FIG. 8 illustrates a flow diagram of a method 800 for performing control and memory accesses over a streaming audio interface, in accordance with some embodiments. Referring to FIG. 8, method 800 includes operations 802, 804, 806, and 808, which may be executed by the circuitry of the device SoC 604 (e.g., the SDC 611 in FIG. 6) or another processor of a computing device (e.g., hardware processor 902 of device 900 illustrated in FIG. 9).

At operation 802, an audio frame is decoded, where the audio frame is received via a streaming audio interface. For example, SDC 702 is configured to decode an audio frame 749 which is received via the streaming audio interface 732.

At operation 804, the decoded audio frame is processed according to a streaming audio protocol associated with the streaming audio interface, to obtain corresponding control data and periodic streaming audio data. For example, SDC 702 is further configured to process the decoded audio frame according to a streaming audio protocol (e.g., an SNDW protocol) to obtain corresponding control data 750 and periodic streaming audio data (e.g., audio data 752).

At operation 806, the control data is parsed to obtain a memory address pointer. For example, SDC 702 is further configured to parse the control data 750 to obtain a memory address pointer.

At operation 808, memory access to local memory is performed based on the memory address pointer. For example, SDC 702 performs memory access to the local memory 708 based on the memory address pointer.

FIG. 9 illustrates a block diagram of an example machine 900 upon which any one or more of the techniques (e.g., methodologies) discussed herein may perform. In alternative embodiments, the machine 900 may operate as a standalone device or may be connected (e.g., networked) to other machines. In a networked deployment, machine 900 may operate in the capacity of a server machine, a client machine, or both in server-client network environments. In an example, the machine 900 may act as a peer machine in a peer-to-peer (P2P) (or other distributed) network environment. The machine 900 may be a personal computer (PC), a tablet PC, a set-top box (STB), a personal digital assistant (PDA), a portable communications device, a mobile telephone, a smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Machine (e.g., computer system) 900 may include a hardware processor 902 (e.g., a central processing unit (CPU), a graphics processing unit (GPU), a hardware processor core, or any combination thereof), a main memory 904, and a static memory 906, some or all of which may communicate with each other via an interlink (e.g., bus) 908.

Specific examples of main memory 904 include Random Access Memory (RAM), and semiconductor memory devices, which may include, in some embodiments, storage locations in semiconductors such as registers. Specific examples of static memory 906 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 900 may further include a display device 910, an input device 912 (e.g., a keyboard), and a user interface (UI) navigation device 914 (e.g., a mouse). In an example, the display device 910, input device 912, and UI navigation device 914 may be a touch screen display. The machine 900 may additionally include a storage device (e.g., drive unit or another mass storage device) 916, a signal generation device 918 (e.g., a speaker), a network interface device 920, and one or more sensors 921, such as a global positioning system (GPS) sensor, compass, accelerometer, or other sensors. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, the processor 902 and/or instructions 924 may comprise processing circuitry and/or transceiver circuitry.

The storage device 916 may include a machine-readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the storage device 916 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 922 is illustrated as a single medium, the term “machine-readable medium” may include a single medium or multiple media (e.g., a centralized or distributed database, and/or associated caches and servers) configured to store one or more instructions 924.

An apparatus of the machine 900 may be one or more of a hardware processor 902 (e.g., a central processing unit (CPU), a graphics processing unit (GPU), a hardware processor core, or any combination thereof), a main memory 904 and a static memory 906, one or more sensors 921, a network interface device 920, antennas 960, a display device 910, an input device 912, a UI navigation device 914, a storage device 916, instructions 924, a signal generation device 918, and an output controller 928. The apparatus may be configured to perform one or more of the methods and/or operations disclosed herein. The apparatus may be intended as a component of the machine 900 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 924 may further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 920 may include one or more physical jacks (e.g., Ethernet, coaxial, or phone jacks) or one or more antennas to connect to the communications network 926. In an example, the network interface device 920 may include one or more antennas 960 to wirelessly communicate using at least one single-input multiple-output (SIMO), multiple-input multiple-output (MIMO), or multiple-input single-output (MISO) techniques. In some examples, the network interface device 920 may wirelessly communicate using Multiple User MIMO techniques. The term “transmission medium” shall be taken to include any intangible medium that is capable of storing, encoding, or carrying instructions for execution by the machine 900, and includes digital or analog communications signals or other intangible media to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in a number of environments such as part of a wireless local area network (WLAN), 3rd Generation Partnership Project (3GPP) Universal Terrestrial Radio Access Network (UTRAN), or Long-Term-Evolution (LTE) or a Long-Term-Evolution (LTE) communication system, although the scope of the disclosure is not limited in this respect.

Antennas referred to herein may comprise one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each of antennas and the antennas of a transmitting station. In some MIMO embodiments, antennas may be separated by up to 1/10 of a wavelength or more.

Described implementations of the subject matter can include one or more features, alone or in combination as illustrated below by way of examples.

Example 1 is a device system-on-a-chip (SoC) comprising: a streaming audio interface; local memory; and a device controller coupled to the memory, the device controller to: decode an audio frame, the audio frame received via the streaming audio interface; process the decoded audio frame according to a streaming audio protocol to obtain corresponding control data and periodic streaming audio data; parse the control data to obtain a memory address pointer; and perform memory access to the local memory based on the memory address pointer.

In Example 2, the subject matter of Example 1 includes subject matter where the streaming audio interface is a SoundWire audio interface, and the audio frame is a SoundWire audio frame.

In Example 3, the subject matter of Example 2 includes subject matter where the device controller is to: forward the periodic streaming audio data of the SoundWire audio frame to a local buffer, the local buffer being separate from the local memory.

In Example 4, the subject matter of Examples 1-3 includes subject matter where the device controller is further to process the control data to obtain a memory access command; and determine the memory address pointer based on an address mapping table and the memory access command.

In Example 5, the subject matter of Example 4 includes subject matter where the device controller is further to: perform a verification of the memory address pointer.

In Example 6, the subject matter of Example 5 includes subject matter where the device controller is further to: perform the memory access command using the memory address pointer associated with the local memory, based on a result of the verification indicating that the memory address pointer is valid.

In Example 7, the subject matter of Examples 5-6 includes, a digital signal processor (DSP), and wherein the device controller is further to: cause the DSP to perform a validation of the local memory, based on a result of the verification indicating that the memory address pointer is invalid.

In Example 8, the subject matter of Example 7 includes subject matter where the device controller is further to: determine an updated memory address pointer after the validation, based on the address mapping table and the memory access command; and perform the memory access command using the updated memory address pointer associated with the local memory.

In Example 9, the subject matter of Examples 7-8 includes subject matter where the device controller is further to: cause the DSP to transition from a low-power state to a normal power state before performing the validation of the local memory.

In Example 10, the subject matter of Examples 1-9 includes subject matter where the device controller is further to: process the decoded audio frame according to the streaming audio protocol to further obtain bulk data.

In Example 11, the subject matter of Example 10 includes subject matter where the device controller is further to process the bulk data to obtain a second memory access command; and determine a second memory address pointer based on an address mapping table and the second memory access command.

In Example 12, the subject matter of Example 11 includes subject matter where the device controller is further to: perform the second memory access command using the second memory address pointer associated with the local memory, wherein the second memory address pointer and the memory address pointer are associated with corresponding non-overlapping memory address spaces of the local memory.

Example 13 is a method for performing memory access, the method comprising: decoding an audio frame, the audio frame received via a streaming audio interface; processing the decoded audio frame according to a streaming audio protocol associated with the streaming audio interface, to obtain corresponding control data and periodic streaming audio data; parsing the control data to obtain a memory address pointer; and performing memory access to a local memory based on the memory address pointer.

In Example 14, the subject matter of Example 13 includes, processing the control data to obtain a memory access command; and determining the memory address pointer based on an address mapping table and the memory access command.

In Example 15, the subject matter of Example 14 includes, performing a verification of the memory address pointer.

In Example 16, the subject matter of Example 15 includes, performing the memory access command using the memory address pointer associated with the local memory, based on a result of the verification indicating that the memory address pointer is valid.

In Example 17, the subject matter of Examples 15-16 includes, causing a digital signal processor (DSP) to transition from a low-power state to a normal power state; and causing the DSP to perform a validation of the local memory, based on a result of the verification indicating that the memory address pointer is invalid.

In Example 18, the subject matter of Example 17 includes, determining an updated memory address pointer after the validation, based on the address mapping table and the memory access command; and performing the memory access command using the updated memory address pointer associated with the local memory.

Example 19 is a device system-on-a-chip (SoC) comprising: a streaming audio interface; local memory; a digital signal processor (DSP); and a device controller coupled to the streaming audio interface, the local memory, and the DSP, the device controller to decode an audio frame, the audio frame received via the streaming audio interface; process the decoded audio frame according to a streaming audio protocol to obtain corresponding control data and periodic streaming audio data, the control data comprising a memory access command; determine a memory address pointer based on an address mapping table and the memory access command; and perform memory access to the local memory based on the memory address pointer.

In Example 20, the subject matter of Example 19 includes subject matter where the device controller is further to: cause the DSP to transition from a low-power state to a normal power state to perform a validation of the local memory, based on a verification of the local memory indicating that the memory address pointer is invalid; determine an updated memory address pointer after the validation, based on the address mapping table and the memory access command; and perform the memory access command using the updated memory address pointer associated with the local memory.

In Example 21, the subject matter of Example 19 includes subject matter where the control data further comprises a set of control register Writes and Reads issued by a remote host, and wherein the device controller is further to perform physical layer (PHY) programming of a physical layer of the device SoC based on executing the control register Writes and Reads.

Example 22 is at least one machine-readable medium including instructions that, when executed by processing circuitry, cause the processing circuitry to perform operations to implement any of Examples 1-21.

Example 23 is an apparatus comprising means to implement any of Examples 1-21.

Example 24 is a system to implement any of Examples 1-21.

Example 25 is a method to implement any of Examples 1-21.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined regarding the appended claims, along with the full scope of equivalents to which such claims are entitled.

1. A device system-on-a-chip (SoC) comprising:
a streaming audio interface;
local memory; and
a device controller coupled to the local memory, the device controller to:
decode an audio frame to generate a decoded audio frame, the audio frame received via the streaming audio interface;
process the decoded audio frame according to a streaming audio protocol to obtain corresponding control data and periodic streaming audio data;
parse the control data to obtain a memory address pointer; and
perform memory access to the local memory based on the memory address pointer.

2. The device SoC of claim 1, wherein the streaming audio interface is a SoundWire audio interface, and the audio frame is a SoundWire audio frame.

3. The device SoC of claim 2, wherein the device controller is to:
forward the periodic streaming audio data of the SoundWire audio frame to a local buffer, the local buffer being separate from the local memory.

4. The device SoC of claim 1, wherein the device controller is further to:
process the control data to obtain a memory access command; and
determine the memory address pointer based on an address mapping table and the memory access command.

5. The device SoC of claim 4, wherein the device controller is further to:
perform a verification of the memory address pointer.

6. The device SoC of claim 5, wherein the device controller is further to:
perform the memory access command using the memory address pointer associated with the local memory, based on a result of the verification indicating that the memory address pointer is valid.

7. The device SoC of claim 5, further comprising a digital signal processor (DSP), and wherein the device controller is further to:
cause the DSP to perform a validation of the local memory, based on a result of the verification indicating that the memory address pointer is invalid.

8. The device SoC of claim 7, wherein the device controller is further to:
determine an updated memory address pointer subsequent to the validation, based on the address mapping table and the memory access command; and
perform the memory access command using the updated memory address pointer associated with the local memory.

9. The device SoC of claim 7, wherein the device controller is further to:
cause the DSP to transition from a low-power state to a normal power state before performing the validation of the local memory.

10. The device SoC of claim 1, wherein the device controller is further to:
process the decoded audio frame according to the streaming audio protocol to further obtain bulk data.

11. The device SoC of claim 10, wherein the device controller is further to:
process the bulk data to obtain a second memory access command; and
determine a second memory address pointer based on an address mapping table and the second memory access command.

12. The device SoC of claim 11, wherein the device controller is further to:
perform the second memory access command using the second memory address pointer associated with the local memory, wherein the second memory address pointer and the memory address pointer are associated with corresponding non-overlapping memory address spaces of the local memory.

13. A method for performing memory access, the method comprising:
decoding an audio frame to generate a decoded audio frame, the audio frame received via a streaming audio interface;
processing the decoded audio frame according to a streaming audio protocol associated with the streaming audio interface, to obtain corresponding control data and periodic streaming audio data;
parsing the control data to obtain a memory address pointer; and
performing memory access to a local memory based on the memory address pointer.

14. The method of claim 13, further comprising:
processing the control data to obtain a memory access command; and
determining the memory address pointer based on an address mapping table and the memory access command.

15. The method of claim 14, further comprising:
performing a verification of the memory address pointer.

16. The method of claim 15, further comprising:
performing the memory access command using the memory address pointer associated with the local memory, based on a result of the verification indicating that the memory address pointer is valid.

17. The method of claim 15, further comprising:
causing a digital signal processor (DSP) to transition from a low-power state to a normal power state; and
causing the DSP to perform a validation of the local memory, based on a result of the verification indicating that the memory address pointer is invalid.

18. The method of claim 17, further comprising:
determining an updated memory address pointer subsequent to the validation, based on the address mapping table and the memory access command; and
performing the memory access command using the updated memory address pointer associated with the local memory.

19. A device system-on-a-chip (SoC) comprising:
a streaming audio interface;
local memory;
a digital signal processor (DSP); and
a device controller coupled to the streaming audio interface, the local memory, and the DSP, the device controller to:
decode an audio frame to generate a decoded audio frame, the audio frame received via the streaming audio interface;
process the decoded audio frame according to a streaming audio protocol to obtain corresponding control data and periodic streaming audio data; the control data comprising a memory access command;
determine a memory address pointer based on an address mapping table and the memory access command; and
perform memory access to the local memory based on the memory address pointer.

20. The device SoC of claim 19, wherein the device controller is further to:
cause the DSP to transition from a low-power state to a normal power state to perform a validation of the local memory, based on a verification of the local memory indicating that the memory address pointer is invalid;
determine an updated memory address pointer subsequent to the validation, based on the address mapping table and the memory access command; and
perform the memory access command using the updated memory address pointer associated with the local memory.

21. (canceled)
